(19) United States
(12) Patent Application Publication
(10) Pub. No.: US 2026/0059217 A1
(43) Pub. Date: Feb. 26, 2026

(54) STEREO HEADSET WITH FERROFLUID DISPLAY

(71) Applicant: Volta Audio LLC, Portland, OR (US)

(72) Inventors: Oscar Harold, Portland, OR (US); Theo Ochwat, Portland, OR (US); William Faust, Portland, OR (US)

(21) Appl. No.: 19/229,384

(22) Filed: Jun. 5, 2025

Related U.S. Application Data
(60) Provisional application No. 63/685,355, filed on Aug. 21, 2024.

(51) Int. Cl. H04R 1/02; H04R 1/10

(52) U.S. Cl. CPC H04R 1/028; H04R 1/1008

(57) ABSTRACT

Audio headsets include an earpiece. The earpiece has an audio part that includes a transducer which converts an audio signal into sound, and a visualization part that includes a ferrofluid which physically responds to the audio signal.

### BACKGROUND

### Technical Field

Described herein are embodiments related to headphones and, more particularly, to headphones with responsive ferrofluid visualization.

### Description of the Related Art

Audio headsets provide audio directly to a user in a way that does not disrupt bystanders, giving the user a private listening experience. Audio headsets can be constructed to provide high fidelity audio and to exclude sounds from the user's surroundings, which gives a superior listening experience. Audio headsets have furthermore become a fashion item. They become an element of the user's personal style.

### SUMMARY

An audio headset includes an earpiece. The earpiece has an audio part that includes a transducer, which converts an audio signal into sound, and a visualization part that includes a ferrofluid, which magnetically couples to the transducer to physically respond to the audio signal.

An audio headset includes an earpiece. An audio part includes a transducer, which converts an audio signal into sound, and an attachment point. A visualization control circuitry controls an electromagnet responsive to the audio signal. A visualization part includes a ferrofluid which magnetically couples to the electromagnet to physically respond to the audio signal. The visualization part separably attaches to the attachment point.

An audio headset includes a headband and earpieces attached to the headband. An audio part of each earpiece includes a transducer, which converts an audio signal into sound, and an attachment point. Visualization control circuitry of each earpiece controls an electromagnet responsive to the audio signal. A visualization part of each earpiece includes a ferrofluid which magnetically couples to the electromagnet to physically respond to the audio signal. The visualization part separably attaches to the attachment point.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a perspective view of an audio headset having a ferrofluid visualization display, in accordance with an embodiment of the present principles;

FIG. 2 is a schematic diagram of an earpiece having a ferrofluid visualization display, in accordance with an embodiment of the present principles; and

FIG. 3 is a schematic diagram of an earpiece having a ferrofluid visualization display, in accordance with an embodiment of the present principles.

### DETAILED DESCRIPTION

Audio headsets are not merely functional devices that provide high-fidelity audio, but also visual constructs that can enhance and complement the user's visual style. In addition to passive visual elements, such as color and physical design, the present embodiments incorporate active visualizations. In particular, a ferrofluid is held within a clear enclosure. Electronics within the headset manipulate a magnetic field within enclosure, which in turn causes changes to the position and shape of the ferrofluid. In some cases these changes to the magnetic field may be responsive to changes in the audio to generate a unique visual display that corresponds to whatever the user is listening to.

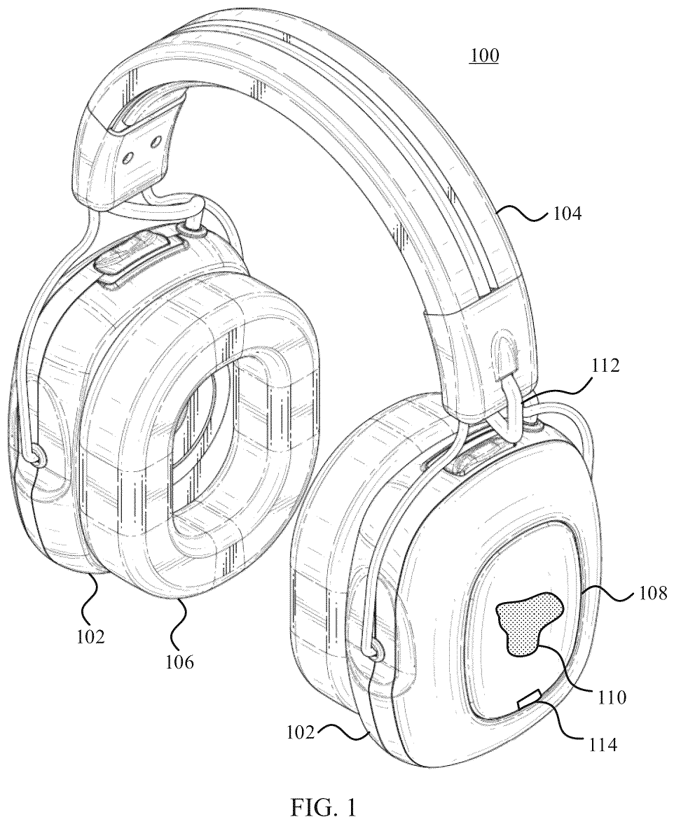

Referring now to FIG. 1, a perspective view is shown of a stereo headset 100 with a ferrofluid display. The headset 100 includes two earpieces 102 mounted to a headband 104. Each earpiece 102 includes a cushion 106 that serves to comfortably rest around the user's ear and provides audio isolation between the user's ear and the environment.

Each earpiece 102 may include a clear enclosure 108. The enclosure 108 may include leak-proof glass or a clear plastic material that contains a ferrofluid 110. In some embodiments the ferrofluid 110 may be a simple black, while in other embodiments the ferrofluid 110 may have any appropriate color.

Each earpiece 102 includes a transducer that converts an electrical audio signal to an acoustic signal. The transducer includes electromagnetic elements, where electromagnetic fields are generated to move a permanent magnet. The motion of the permanent magnet in turn moves a diaphragm that causes air pressure to change, thus creating sound. The changing electromagnetic fields and the movement of the permanent magnet cause changing magnetic fields at the ferrofluid 110, which causes the ferrofluid 110 to move and change in shape. The ferrofluid 110, being constrained within the enclosure, moves within an essentially two-dimensional range. Thus the changing amplitudes and frequencies of the audio signal received by the headset 100 are represented visually by motion of the ferrofluid 110. In some embodiments the enclosure 108 may include a light source 114 for viewing the ferrofluid 110 in low-light conditions. The light source 114 may include any appropriate light source, such as a light emitting diode (LED).

In some embodiments the audio signal may be provided by a cable. In other embodiments the audio signal may be provided wirelessly. Communication between the earpieces 102 and a receiver, whether wired or wireless, may be accomplished using a cable 112. In some embodiments the audio signal may be stereo, with two separate channels being reproduced by respective earpieces 102.

The headband 104 may be attached to the earpieces 102 by a rigid metal wire mechanism that perpendicularly enters the earpieces 102 on a side surface. The earpieces 102 can swivel on the ends of the wire attachment. The headband 104 may include a centrally positioned top piece with a padded surface and end pieces that are adjustable in length. Each end piece may extend from a top portion by varying increments, using a sliding mechanism with an internal metal band to adjust overall fit to a user's head.

Wiring 112 exits from the top of the earpieces to pass into the headband through a hole in the end piece of the headband 104.

The earpiece 102 may be divided into two functional parts. One part may include the enclosure 108, a fluid container, and the other part may include electronic components. The fluid container may be fabricated from glass, acrylic, polyethylene terephthalate (PTA) plastic, and may be treated to resist staining from the ferrofluid. The fluid container may further have a protective anti-scratch coating. A back side of the fluid container may be white and opaque, while its front and side surfaces may be transparent and clear. The enclosure 108 may removably connect to the electronics-containing half by an attachment mechanism, with a release button positioned on a surface of the earpiece 102.

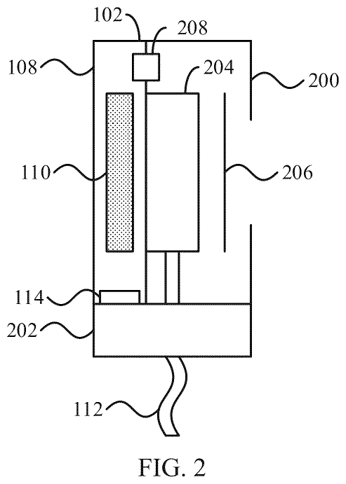

Referring now to FIG. 2, a schematic view of an earpiece 102 with direct audio coupling is shown. The enclosure 108 is shown attached to an audio system 200. In some embodiments the enclosure 108 may be made removable through an attachment mechanism, described in greater detail below. The audio system 200 interfaces with a control system 202, which receives audio signals from an external source, for example via cable 112 or via a wireless transceiver. The control system 202 may perform signal processing tasks, such as noise cancelling and equalization.

The control system 202 communicates the audio signal, with or without processing, to a transducer 204. The transducer includes an electromagnet and a permanent magnet. The audio signal causes an electromagnetic field from the electromagnet to change, which changes the position of the permanent magnet. The permanent magnet is attached to a diaphragm 206. As the permanent magnet moves, so does the diaphragm 206, causing changes in air pressure that are perceived by the ear as sound. Due to its proximity to the enclosure 108, the transducer 204 further electromagnetically couples with the ferrofluid 110, causing its movement.

In some embodiments, an attachment mechanism 208 connects the enclosure 108 to the audio system 200. In some cases the attachment mechanism 208 may include a hook-and-clip structure, where the enclosure 108 includes a hook that fits into an attachment point, such as a slot, on the audio system 200. A spring-loaded clip may catch the hook and hold it into place. To release the enclosure 108, a button on an external surface of the earpiece 102 may be depressed to compress the spring and release the hook. In some cases a plastic leaf spring may be used to press the assembly out. This makes it possible to replace the enclosure 108, for example for service or to replace it with an enclosure having a different color of ferrofluid or physical design. In some embodiments, the enclosure 108 may have the slot and the audio system may have the hook.

The earpiece 102 may include a main printed circuit board (PCB), battery cells, an electromagnet, a speaker driver, and an auxiliary button PCB. In some embodiments the main PCB may integrate elements of the control system 202 and the audio system 200. The main PCB may include components of the control system 202, for example integrating components that control wired and/or wireless audio reception. The main PCB may further include a charging port and/or data port. The earpieces 102 may include outward-facing LEDs 114 which may, for example, employ light guides and optical lenses to channel emitted light diffusely into the enclosure 108 from the side. Such illumination can enhance the visual depth and nuance of the ferrofluid as it moves. The main PCB may further include an aperture to allow the electromagnet to pass through, ensuring the electromagnet occupies minimal depth within the housing. Battery cells may be arranged within interior space of the earpieces 102 to efficiently use the housing volume. The speaker driver may be installed directly beneath the ear cushion 106 in close proximity to the user's ear.

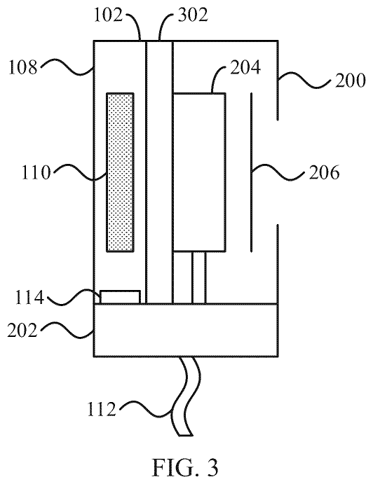

Referring now to FIG. 3, a schematic view of an earpiece 102 with separate ferrofluid control is shown. In some embodiments there may be separate visualization control circuitry 302 that can control the movement of the ferrofluid 110 independent of the audio signal. In such embodiments, the separate visualization control circuitry 302 may include one or more separate electromagnets that couple with the ferrofluid 110 to control its movement, in addition to or to the exclusion of the audio signal. In some embodiments the enclosure 108 and the separate visualization control circuitry 302 may be shielded from the transducer 204, preventing interference between the audio system and the visualization system.

In embodiments with separate visualization control circuitry 302, the separate visualization control circuitry 302 may receive instructions from the control system 202 or may be controlled separately. The separate visualization control circuitry 302 may thereby receive instructions, for example from a user's mobile device or according to one or more preset patterns, that dictate how the ferrofluid 110 will behave. For example, the separate visualization control circuitry 302 may be controlled to cause the ferrofluid 110 to move in a particular pattern or to hold a predetermined shape. The light source 114 may similarly be controlled to provide dynamic lighting effects, selecting colors and animated effects to complement the motion of the ferrofluid 110.

The separate visualization control circuitry 302 may therefore apply varying electromagnetic fields, for example applying pulses in time with a rhythm of music being played. This can be accomplished by applying a Fourier transform to the audio signal, breaking it into different frequencies, which can be used to identify one or more frequencies that characterize the audio signal. Electromagnetic pulses may then be applied in time with one or more of these identified frequencies. User software can furthermore control this response, for example by manually selecting a frequency band (e.g., “high,”“mid,”or “low”) that governs how the ferrofluid 110 acts.

The separate visualization control circuitry 302 of each earpiece 102 may communicate with one another via cable 112. In such embodiments, the ferrofluids 110 of both earpieces 102 may be controlled in a similar manner, using the same settings for both. In some embodiments the ferrofluids 110 of each earpiece 102 may be controlled with different settings. In some embodiments, the ferrofluids 110 of the two earpieces 102 may be controlled by distinct audio signals, such as the channels of a stereo signal. In some embodiments the separate visualization control circuitry 302 may combine the channels of the stereo signal into a monophonic signal to control the ferrofluids 110 of both earpieces 102 in the same way.

Although the attachment mechanism 208 is not shown in this embodiment, such an attachment mechanism may be included in embodiments with separate ferrofluid control. In some embodiments the separate visualization control circuitry 302 may be included in a same assembly as the enclosure 108, such that both may be detached from the audio system 200. In other embodiments the separate visualization control circuitry 302 may be included in a same assembly as the audio system 200, such that both may be detached from the enclosure 108.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the term “direct” or “directly,” in reference to a connection between two circuit components, refers to a connection that includes only a transmission line or interconnect, without any other active or passive circuit components in the connection between the two circuit components.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of stereo headsets with ferrofluid displays (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. An audio headset, comprising:
an earpiece that includes:
an audio part that includes a transducer which converts an audio signal into sound; and
a visualization part that includes a ferrofluid which magnetically couples to the transducer to physically respond to the audio signal.

2. The audio headset of claim 1, wherein the audio part includes an attachment point and wherein the visualization part separably attaches to the attachment point.

3. The audio headset of claim 2, wherein the attachment point includes a slot and wherein the visualization part includes a hook that attaches to the slot.

4. The audio headset of claim 1, wherein the visualization part includes a clear enclosure that holds the ferrofluid separate from the audio part.

5. The audio headset of claim 1, wherein the visualization part includes a light source that illuminates the ferrofluid.

6. An audio headset, comprising:
an earpiece that includes:
an audio part that includes a transducer, which converts an audio signal into sound, and an attachment point;
visualization control circuitry that controls an electromagnet responsive to the audio signal; and
a visualization part that includes a ferrofluid which magnetically couples to the electromagnet to physically respond to the audio signal, wherein the visualization part separably attaches to the attachment point.

7. The audio headset of claim 6, further comprising electromagnetic shielding between the visualization control circuitry and the audio part.

8. The audio headset of claim 6, wherein the visualization part includes a clear enclosure that holds the ferrofluid separate from the audio part.

9. The audio headset of claim 6, wherein the visualization part includes a light source that illuminates the ferrofluid.

10. The audio headset of claim 6, wherein the attachment point includes a slot and wherein the visualization part includes a hook that attaches to the slot.

11. The audio headset of claim 6, wherein the visualization control circuitry performs a Fourier transform on the audio signal and controls the ferrofluid with electromagnetic pulses in accordance with a frequency from the Fourier transform of the audio signal.

12. The audio headset of claim 11, wherein the visualization control circuitry controls the ferrofluid in accordance with a user-defined setting.

13. The audio headset of claim 6, wherein the visualization control circuitry is integrated with the audio part.

14. An audio headset, comprising:
a headband; and
earpieces attached to the headband, each earpiece including:
an audio part that includes a transducer, which converts an audio signal into sound, and an attachment point;
visualization control circuitry that controls an electromagnet responsive to the audio signal; and
a visualization part that includes a ferrofluid which magnetically couples to the electromagnet to physically respond to the audio signal, wherein the visualization part separably attaches to the attachment point.

15. The audio headset of claim 14, wherein each earpiece further includes electromagnetic shielding between the visualization control circuitry and the audio part.

16. The audio headset of claim 14, wherein the visualization parts include a clear enclosure that holds the ferrofluid separate from the audio part.

17. The audio headset of claim 14, wherein the visualization parts include a light source that illuminates the ferrofluid.

18. The audio headset of claim 14, wherein the attachment points include a slot and wherein the visualization parts include a hook that attaches to the slot.

19. The audio headset of claim 14, wherein the visualization control circuitry performs a Fourier transform on the audio signal and controls the ferrofluid with electromagnetic pulses in accordance with a frequency from the Fourier transform of the audio signal.

20. The audio headset of claim 14, wherein the visualization control circuitry combines channels of the audio signal to control the ferrofluids in the respective earpieces together.
